(19) United States
(12) Patent Application Publication
(10) Pub. No.: US 2007/0143129 A1
(43) Pub. Date: Jun. 21, 2007

(54) Business website system

(76) Inventor: Fu-Sheng Chiu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/362,020

(22) Filed: Feb. 27, 2006

(30) Foreign Application Priority Data
Dec. 7, 2005 (TW) 94143189

(51) Int. Cl. G06Q 99/00

(52) U.S. Cl. 705/1

(57) ABSTRACT

A network business system with live unidirectional or bidirectional audio-video feed, allowing customers to interact with customer support, customer service, sales agents, live demonstrations, and each other. The website system further features a method for assisting customers in selecting purchases, and provides a method for customers to get bonuses and promotional items through their interaction with the site and with other customers. On the back end, the business method provides for a dispersed support staff to reduce overhead expenses.

### BACKGROUND OF THE INVENTION

1. Field of the Invention

The present invention relates to business website systems. More specifically, the present invention discloses a business website system with live two-way interaction and customer purchase assistance.

2. Description of the Prior Art

Traditionally, business website systems have been conservative in their design. Customers are shown selections of products and services, add these to a “shopping cart”, and make their purchases. Support and service, during and after the sales process, are largely afterthoughts handled by email if at all.

However, this leads to customer dissatisfaction in a variety of ways. With little or no direction beyond perhaps a vague recommendation of other items that other customers may have purchased when buying a specific item, customers have difficulty finding items that are a good match for their purposes. Customers also are not well-rewarded for loyalty.

In addition, the lack of live support costs “e-tailers” potential sales, as a customer service representative is not present to lead customers to featured items or to sell related products that work synergistically with the customer's purchase; and many effective sales techniques, such as demonstrations (“demos”), are unavailable on the web.

Therefore there is need for improvement in business website methods and systems.

### SUMMARY OF THE INVENTION

To achieve these and other advantages and in order to overcome the disadvantages of the conventional method in accordance with the purpose of the invention as embodied and broadly described herein, the present invention provides an improved business website system comprising live agent one-on-one support and interactive webcasting of events to multiple customers.

The present invention further provides a method for assisting customers in choosing items that meet their needs.

The present invention further provides a method for rewarding customers for their loyalty, feedback, and willingness to involve themselves in the business website community.

The present invention further provides a business network solution comprising customer service, customer feedback, market survey, product information, service information, product rating, product comparison, interviewing, shipping, purchasing, and feature comparison. Additionally, the present invention is presented in a single page fashion so that customers can easily navigate the website. Many of the components of the solution offer real-time audio video interaction between customers and business personnel.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is an example layout of a business website system according to an embodiment of the present invention;

FIG. 2 is an example layout of a business website system according to an embodiment of the present invention;

FIG. 3 is a detail view of a scrolling still image bar control for a business website system according to an embodiment of the present invention;

FIG. 4 is a detail view of a multimedia pane for a business website system according to an embodiment of the present invention;

FIG. 5 is an example layout of a business website system according to an embodiment of the present invention; and

FIG. 6 is a diagram of a web business system according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention comprises a plurality of components or modules that improves the effectiveness of commerce and increases user satisfaction by providing these modules in a unified environment.

In an embodiment of the present invention, the business website system comprises such modules as sales, marketing, customer service, customer feedback, market survey, product information, service information, product rating, product comparison, interviewing, shipping, purchasing, and feature comparison. Additionally, the present invention is presented in a single page fashion so that customers can easily navigate the website. Many of the components of the solution offer real-time audio video interaction between customers and business personnel.

For example, if a user is viewing various products and has specific questions they would like answered, the user simply clicks a control to access a live customer service representative or sales personnel. After connecting to the representative, real-time audio and video is provided between the business representative and potential customer. In this way, the user can receive product information or assistance immediately. This increases user satisfaction and the likelihood the user will make a purchase. Additionally, since the website solution is a single page interface, the various modules are presented in an easy to use format without having to go through several pages via menus to find information.

Furthermore, users are often frustrated filling out complex order forms. However, with the present invention, if the user is having trouble, they can immediately contact a sales representative who can help them in completing the order form via real-time audio and video.

Following is a description of the interface utilized by the business website system of the present invention.

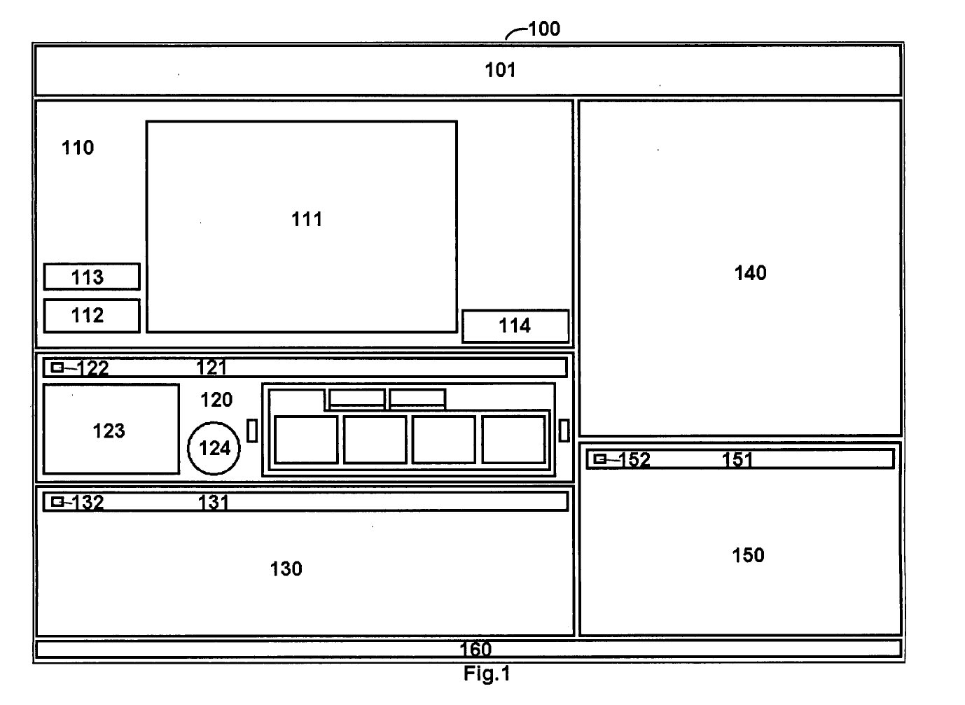

Please refer to FIG. 1, which shows an example layout of a business website system according to an embodiment of the present invention. The page 100 has a title area 101, a multimedia pane 110, a scrolling still image control 120, an event pane 130, an advertising pane 140, a multifunction pane 150, and a footer 160. This example layout is divided into a left section and a right section; the left section comprises the multimedia pane 110, the scrolling still image control 120, and the event pane 130; and the right section comprises the advertising pane 140 and the multifunction pane 150. The scrolling still image control 120, the event pane 130, and the multifunction pane 150 have windowshade bars 121, 131, and 151 respectively, and toggle buttons 122, 132, and 152 respectively; clicking on a toggle button 122,132 of an open pane causes its respective pane to shrink vertically to the size of its respective windowshade bar, thus freeing up area in the page for the multimedia pane 110 to enlarge, increasing the size of its display area 111; it may retain the aspect ratio of the display area 111 or alter it as appropriate to its content.

Conversely, clicking on a toggle button 122,132 of a closed pane causes its respective pane to enlarge vertically to its original layout size, and reducing the available area on the page for the multimedia pane 110. The multimedia pane 110 automatically resizes to take up the maximum available area, thereby providing the user with the largest possible view of the current multimedia presentation in the display area 111, again either maintaining or altering the aspect ratio of the presentation as appropriate to its content. Clicking on the toggle button 152 will likewise cause the multifunction pane 150 to reduce or enlarge its size, depending on whether the multifunction pane 150 is currently open or closed respectively, thereby allowing the advertising pane 140 to, respectively, grow or shrink automatically. The multifunction pane 150 has a wide variety of possible applications, comprising customer surveys, customer service chat room, application for distributorship, product or service information, product rating surveys, and feature comparisons among multiple products.

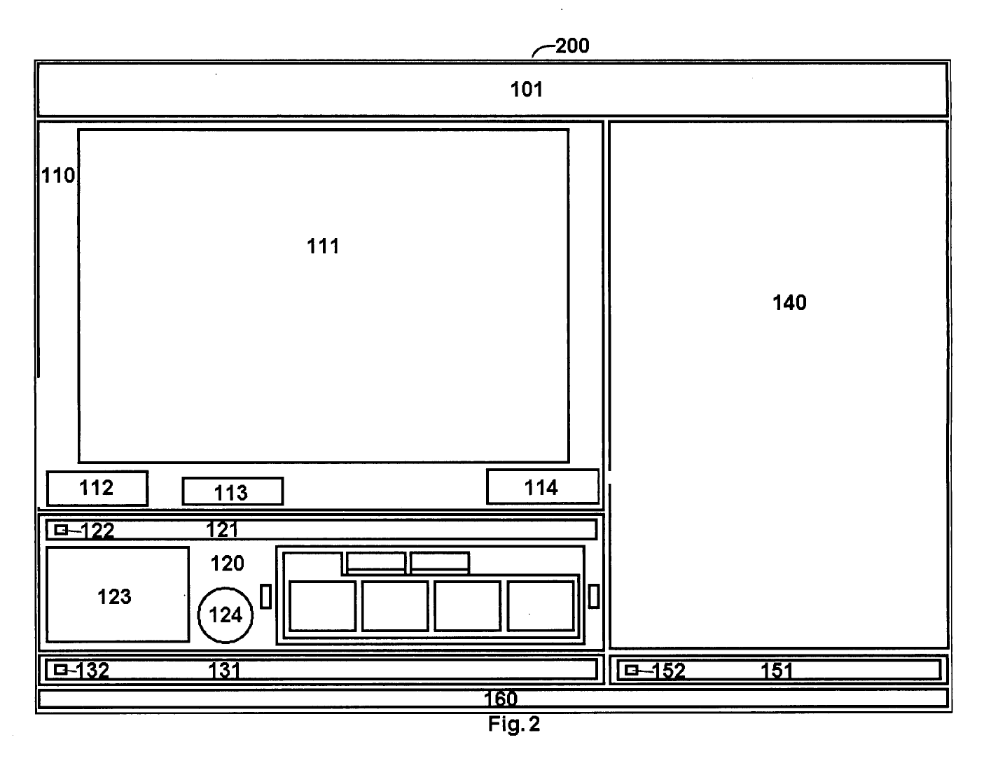

Please refer to FIG. 2, which shows an example layout of a business website system according to an embodiment of the present invention. This layout shows a page 200 with the event panel 130 reduced to the size of its windowshade bar 131 after its toggle button 132 has been clicked, and the multifunction panel 150 likewise reduced to the size of its windowshade bar 151 after its toggle button 152 has been clicked; the multimedia pane 110 and advertising pane 140 have grown correspondingly, with the display area 111 of the multimedia pane 110 likewise having increased in size, and with the volume control 112, pause/play button 113, and order button 114 having been rearranged automatically by a layout manager to accommodate the largest possible display area 111 while retaining the aspect ratio of the display area 111.

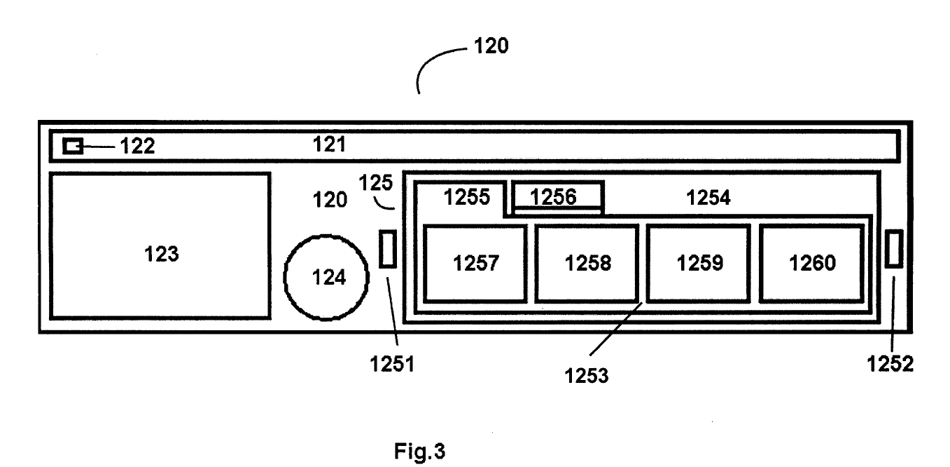

Please refer to FIG. 3, which shows a detail view of a scrolling still image bar control for a business website system according to an embodiment of the present invention. The scrolling still image bar control 120 comprises a windowshade bar 121, a toggle button 122, a preview pane 123, an activation button 124, and a tabbed scrollable list 125. The tabbed scrollable list 125 comprises a left button 1251, a right button 1252, an image area 1253, a tab bar 1254 with a plurality of tabs 1255˜1256, and a plurality of images 1257˜1260. The number of images shown at any given time may vary depending on the size and aspect ratio of the images as well as on the width and height of the image area 1253, and of course on the total number of images to be displayed.

The tab bar 1254 comprises a plurality of tabs 1255˜1256 which are typically used to select among different groupings of products or items or topics; the number of tabs at any given time may vary depending on the choice of the website designer, the number of products or items or topics, and the width of the image area 1253. Tabs 1255˜1256 are labelled with a brief description of the grouping. Clicking on a tab 1255,1256 typically selects a grouping of products or items or topics, causing a related series of images 1257˜1260 to scroll in the image area 1253. Clicking on the left button 1251 or the right button 1252 causes the images to scroll left or right respectively.

In addition, images may automatically scroll in a default direction when the user has not clicked on either the left button 1251 or right button 1252. Clicking on the left button 1251 or right button 1252 may also briefly pause the scrolling behaviour for a configurable amount of time after the button has been clicked, to allow the user to view an item that is presumably of particular interest to have triggered the user action. Clicking on an image 1257,1258,1259,1260 causes a preview to display in the preview pane 123. Clicking on the activation button 124 then causes the full presentation to be shown in the display area 1 11 of the multimedia pane 110.

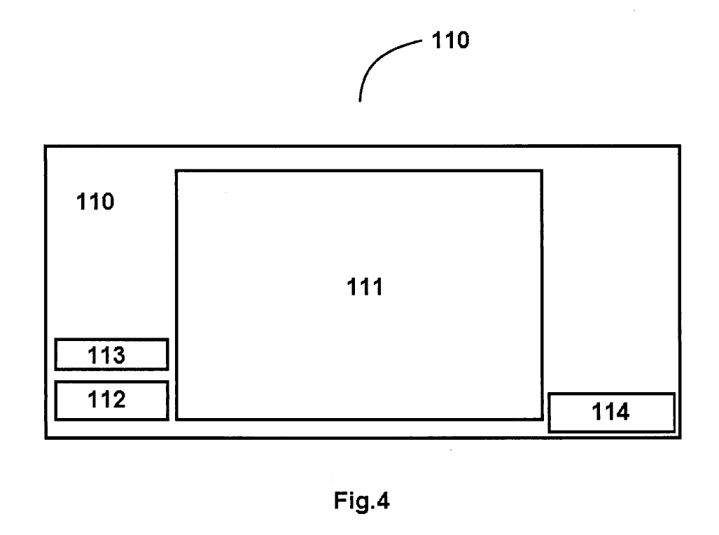

Please refer to FIG. 4, which shows a detail view of a multimedia pane for a business website solution according to an embodiment of the present invention. The multimedia pane 110 comprises a display area 111, a volume control 112, a pause/play button 113, and an order button 114. It displays a sequence of still images or a video, as chosen by the website designer.

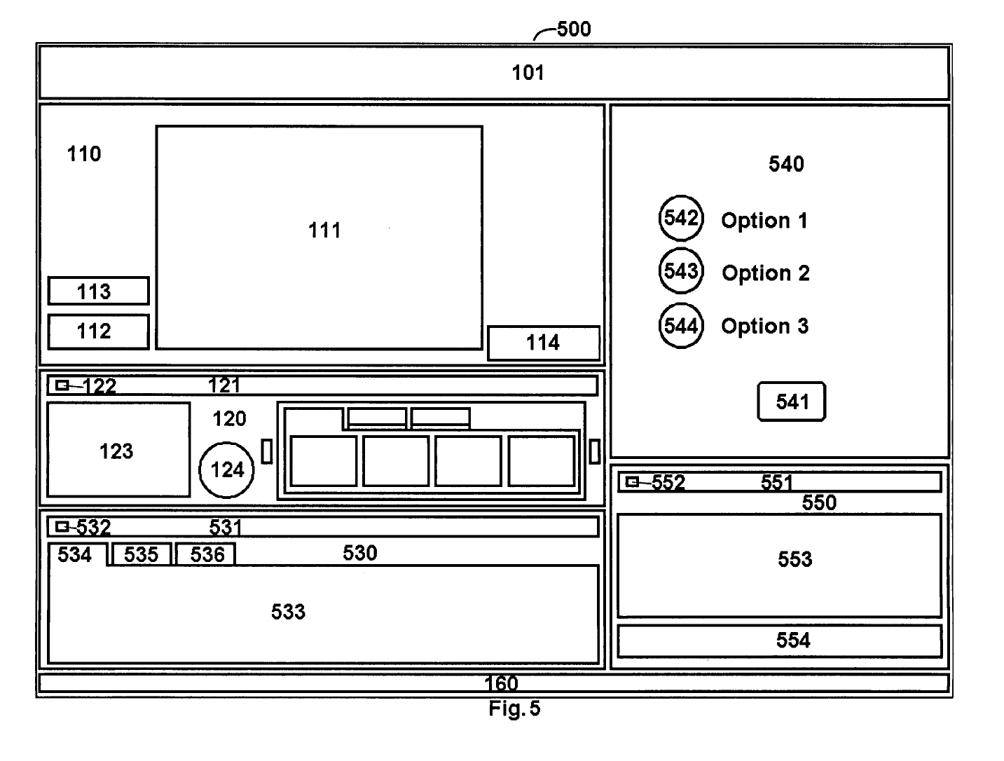

Please refer to FIG. 5, which shows an example layout of a business website system according to an embodiment of the present invention. The interface 500 comprises a title area 101, a multimedia pane 110, a scrolling still image control 120, a poll results pane 530, an advertising and polling pane 540, a chatroom pane 550, and a footer 160. The multimedia pane 110 and scrolling still image control 120 are similar to those in the first embodiment above; however, the other panes are used for different purposes. The poll results pane 530 displays results for the current poll and/or past similar polls, such as overall results for the poll, the product brand and, the individual products. The poll results pane 530 comprises a windowshade bar 531, a toggle button 532, a results display area 533, and a plurality of tabs 534˜536; the tabs allow the user to select among different groupings of products or polls. Please note that more or fewer tabs may be used as desired.

The advertising and polling pane 540 allows sponsors to display advertising and to generate user interest by asking polling questions of the user, such as the best product or the most desirable product. When displaying a poll, a submit button 541 and a plurality of poll choices 542˜544 are displayed for the user to choose from. The chatroom pane 550 allows fans to discuss the event and other topics among themselves, with the discussion optionally being moderated by the site administrators. The chatroom pane 550 comprises a windowshade bar 551, a toggle button 552, a display area 553, and a user entry area 554.

Following is a description of the infrastructure of the business website system of the present invention.

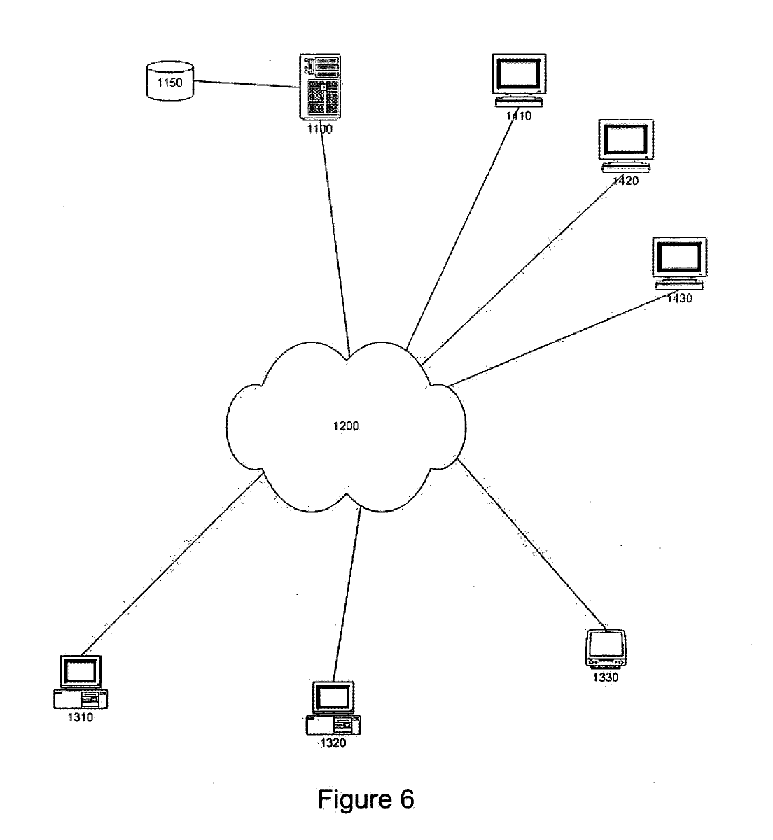

Please refer to FIG. 6, which shows a diagram of a web business system of the present invention. The system 1000 comprises a server 1100 coupled to an internet 1200. A database 1150 is coupled to the server 1100 for storing customer, product, and service information. Customer workstations 1310˜1330 are also coupled to the internet 1200 and communicate with server 1100 through the internet 1200. Service workstations 1410˜1430 are also coupled to the internet 1200 and communicate with server 1100 through the internet 1200. The service workstations 1410˜1430 serve live customer service agents who can assist customers one-on-one with sales, technical support, customer service, or business support. These customer service agents can be located in low cost-of-labor areas served by high-speed internet connectivity.

In addition, the service workstations 1410˜1430 can be used to webcast events to multiple customers, such as a product demonstration, workshop, seminar, or infomercial, with customer workstations 1310˜1330 able to interrogate the presenter about products or services, and with the questions from one customer multicast to the others who are watching and/or listening so that they can benefit from the one customer's questions. While the feed to the customers is preferably audio-video webcast, the customers may send either an audio-video feed to the server 1100 for rebroadcast or may send text through an instant-messenger type interface, depending on the capabilities of the customer workstation 1310˜1330.

An important capability of the business website system is to create a sense of community among customers through the use of appreciation points, stored in the database 1150, and redeemable for goods or services or other rewards. Such points may be awarded for customer reviews of equipment, for participation in events, or for assisting other customers. For example, customer workstations 1310˜1330 can be put into communication amongst each other through the internet 1200 by the server 1100 in order to provide a sense of community and site support. A customer at customer workstation 1310 may have already purchased an item, and a customer at customer workstation 1320 may be interested in said item. The system 1100, determining that both are online at the same time, can offer the customer at customer workstation 1310 appreciation points for assisting the customer at customer workstation 1320.

The business website system of the present invention allows the website to narrow the list of suitable items very rapidly. For example, given an appliance sales site, an initial question might be to ask the customer what type of appliance the customer wants to purchase. The answer limits the set of appliances to, for example, only washing machines. Subsequent narrowing questions might limit the set based on capacity, color, or power requirements. The narrowing questions can be simple yes/no questions, multiple-choice selections, detailed feature comparisons, or other differentiating questions. If multiple choices are still available in the final set and no further narrowing questions exist for the choices, the customer can be asked to explain what differentiates the choices to the customer. The system thus learns how better to serve later customers. In order to improve the chance of receiving a good suggestion, the customer can be rewarded by being given appreciation points for the suggestion.

When completing an order, the system can optionally allow the customer to request live-agent verification of the order, including shipping information. This acts to generate a perceived quality of service in the mind of the customer, and allows marketing at the point of checkout.

As an example, consider a first customer shopping for a gift. The first customer has little idea of what to select. Requesting sales assistance, the first customer is able to discuss the purchase with a customer sales agent and narrow down available choices to a few items of a given type. Requesting a feature comparison of these items, the business website system generates a table showing the major features and highlighting any differences between the items, notably their prices. The table can be reordered according to any of the compared scalar features, e.g., sorting by price or by weight or by default memory size.

The business website system is able to show that a second customer, currently online, has previously purchased one of the items, and the first customer requests live chat with the second customer. The business website system forwards this request to the second customer, with the note that the second customer will be awarded appreciation points for assisting the first customer. After accepting the offer and discussing the item with the first customer, the second customer receives some amount of appreciation points. The discussion may be monitored by the business website system's staff or by automated processes to ensure quality and prevent fraud.

The first customer can then return to the sales agent and discuss extras which would improve the purchase; for example, many electronics items today benefit from purchasing additional memory cards. Targeted advertising during the sales process can also be used; the advertising being displayed to the customer can be based on the current items the first customer is investigating and on previously purchased items, as well as on related items purchased by other customers with the first customer's current items. The customer sales agent may assist the customer in placing the order. Once completed, the first customer can proceed to checkout, where the first customer enters shipping information. The system performs automated verification tasks against the shipping information, such as checking for spelling mistakes and verifying that the postal code matches the city and state/province; if any potential errors are detected, the information is forwarded to a live agent who can interact with the first customer to determine whether it is correct and to make any necessary changes.

Meanwhile, the second customer has noticed that only a few more appreciation points will result in being awarded free shipping. The second customer fills out a marketing survey or customer satisfaction survey, and then enters a review of the item just discussed with the first customer, including commentary on the item and an overall rating. The additional appreciation points permit the second customer to obtain free shipping and/or some other reward on the current purchase. Other rewards might be a small gift, giftwrapping, or faster shipping. The business website system would further note that the second customer has done these things, giving the user a ranking, internal to the system and optionally visible to other customers, to note the second customer's helpfulness and desirability as a customer; this ranking can later be used for other promotions and targeted appreciation mailings.

Marketing and market feedback surveys can be targeted to customers based on items they are currently viewing or on past purchases or on related items. These surveys can be done as “push” type surveys to steer a customer to a product line or product, or as post-purchase satisfaction surveys. Optionally, these surveys can be sponsored by the manufacturers or distributors of product lines to determine what customers are more likely to purchase or to steer customers toward their products through promoting their items.

Subsequently, the first customer receives the products and enters the customer service area of the site to determine usage information, for example, assembly instructions or usage tips. Discussion with live customer service staff allows the first customer's questions to be resolved quickly and correctly, thus improving the first customer's satisfaction with the business website system and increasing the likelihood of additional purchases at a later time.

The system is thus well-suited for delivering product information, product ratings, product comparisons, feature comparisons, purchasing, customer service, consumer feedback, market surveys, shipping, and other business service stages. All customer needs can be met without waiting, and due to the ability to locate service agents in low-cost areas, customer overhead costs can be kept low. High quality of service can be maintained while increasing customer loyalty and satisfaction.

The present invention provides a business network solution comprising customer service, customer feedback, market survey, product information, service information, product rating, product comparison, interviewing, shipping, purchasing, and feature comparison. Additionally, the present invention is presented in a single page fashion so that customers can easily navigate the website. Many of the components of the solution offer real-time audio video interaction between customers and business personnel.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A network business system comprising:
a plurality of modules for conducting business on a network, the plurality of modules comprising:
a customer service module for providing customer service;
a product information module for providing information regarding products or services; and
a purchasing module for receiving orders;
wherein the modules are provided by means of a one page website interface.

2. The network business system of claim 1, further comprising a sales module for providing sales support.

3. The network business system of claim 1, further comprising a shipping module for providing shipping information and for receiving shipping details.

4. The network business system of claim 1, further comprising a customer feedback module for receiving customer feedback.

5. The network business system of claim 1, further comprising a market survey module for conducting surveys.

6. The network business system of claim 1, further comprising a product rating and comparison module for compiling and providing ratings and comparisons of various products or service.

7. The network business system of claim 1, further comprising a feature comparison module for providing information related to comparisons of product or service features.

8. The network business system of claim 1, further comprising a customer support module for providing technical assistance to customers.

9. The network business system of claim 2, wherein the sales module provides real-time audio and video between a user and a sales representative.

10. The network business system of claim 1, wherein the customer service module provides real-time audio and video between a user and a customer service representative.

11. The network business system of claim 8, wherein the customer support module provides real-time audio and video between a customer and a customer support representative.

12. A network business system comprising:
a plurality of modules for conducting business on a network, the plurality of modules comprising:
a customer service module for providing customer service;
a sales module for providing sales support a product information module for providing information regarding products or services;
a purchasing module for receiving orders;
a shipping module for providing shipping information and for receiving shipping details;
a customer feedback module for receiving customer feedback;
a market survey module for conducting surveys; and
a product rating and comparison module for compiling and providing ratings and comparisons of various products or service.

13. The network business system of claim 12, wherein the modules are provided by means of a one page website interface.

14. The network business system of claim 12, further comprising a feature comparison module for providing information related to comparisons of product or service features.

15. The network business system of claim 12, further comprising a customer support module for providing technical assistance to customers.

16. The network business system of claim 12, wherein the sales module provides real-time audio and video between a user and a sales representative.

17. The network business system of claim 12, wherein the customer service module provides real-time audio and video between a user and a customer service representative.

18. The network business system of claim 15, wherein the customer support module provides real-time audio and video between a customer and a customer support representative.

19. A network business system comprising:
a plurality of modules for conducting business on a network, the plurality of modules comprising:
a sales module for providing sales support;
a customer service module for providing customer service;
a customer feedback module for receiving customer feedback;
a market survey module for conducting surveys;
a product information module for providing information regarding products or services;
a product rating and comparison module for compiling and providing ratings and comparisons of various products or service;
a shipping module for providing shipping information and for receiving shipping details;
a purchasing module for receiving orders;
a feature comparison module for providing information related to comparisons of product or service features; and
a customer support module for providing technical assistance to customers;
wherein the modules are provided by means of a one page website interface.

20. The network business system of claim 19, wherein the sales module, customer service module, and customer support module provide real-time audio and video between a user and a representative.
